(19) United States
(12) Patent Application Publication
(10) Pub. No.: US 2021/0407230 A1
(43) Pub. Date: Dec. 30, 2021

(54) A SYSTEM OF SEAMLESS AUTOMATED CUSTOMER ID VERIFICATION AT THE HOTEL ENTRANCE AND RELEASING THE HOTEL ROOM KEY

(71) Applicant: Carrier Corporation, Palm Beach Gardens, FL (US)

(72) Inventors: Santhosh Amuduri, Hyderabad, Telangana (IN); Steve Lyons, Salem, OR (US); Adam Kuenzi, Silverton, OR (US); Mohan Reddy Dumbala, Hyderabad, Telangana (IN); Ramesh Lingala, Hyderabad, Telangana (IN)

(21) Appl. No.: 16/973,397

(22) PCT Filed: Oct. 21, 2019
(86) PCT No.: PCT/US2019/057156

§ 371 Date: Dec. 8, 2020

(30) Foreign Application Priority Data
Nov. 21, 2018 (IN) 201811043794

(51) Int. Cl. G07C 9/00; G07C 9/28; G06K 9/00

(52) U.S. Cl. CPC G07C 9/00563; G06K 9/00288; G07C 9/00904; G07C 9/28

(57) ABSTRACT

A method of granting seamless access to a room including: detecting a location of a mobile device being carried by an individual; determining that the location of the mobile device is located proximate a property entrance to a property; obtaining a picture of a face of the individual using a camera; verifying an identity of the individual in response to at least the picture of the face of the individual; and transmitting a digital room key to the mobile device.

### BACKGROUND

The subject matter disclosed herein generally relates to the field of access control systems, and more particularly to an apparatus and method for communication between access controls of access control systems.

Access controls may be utilized to control access to specific entry point, such as, for example a lock on a door. While mobile devices may be utilized to actuate access controls (i.e., locks) that control access to rooms, the identity of the individual carrying the mobile device is often unknown.

### BRIEF SUMMARY

According to one embodiment, a method of granting seamless access to a room is provided. The method including: detecting a location of a mobile device being carried by an individual; determining that the location of the mobile device is located proximate a property entrance to a property; obtaining a picture of a face of the individual using a camera; verifying an identity of the individual in response to at least the picture of the face of the individual; and transmitting a digital room key to the mobile device.

In addition to one or more of the features described above, or as an alternative, further embodiments may include: transmitting an access request from the mobile device to an access control, the access request including the digital room key; and actuating the access control in response to the digital room key.

In addition to one or more of the features described above, or as an alternative, further embodiments may include: activating a notification on the mobile device when the identity of the individual is being verified.

In addition to one or more of the features described above, or as an alternative, further embodiments may include: activating a notification on the mobile device when the identity of the individual has been verified.

In addition to one or more of the features described above, or as an alternative, further embodiments may include: activating a notification on the mobile device when the digital room key is transmitted.

In addition to one or more of the features described above, or as an alternative, further embodiments may include that the camera is located on the mobile device.

In addition to one or more of the features described above, or as an alternative, further embodiments may include that the camera is a security camera located on the property.

In addition to one or more of the features described above, or as an alternative, further embodiments may include that verifying an identity of the individual in response to at least the picture of the face of the individual further includes: comparing the picture of the face of the individual to a picture previously captured of the individual.

In addition to one or more of the features described above, or as an alternative, further embodiments may include that verifying an identity of the individual in response to at least the picture of the face of the individual further includes: cross-referencing the picture against at least one of a government database and a hotel database.

According to another embodiment, a seamless access system is provided. The seamless access system including: a processor; and a memory including computer-executable instructions that, when executed by the processor, cause the processor to perform operations, the operations including: detecting a location of a mobile device being carried by an individual; determining that the location of the mobile device is located proximate a property entrance to a property; obtaining a picture of a face of the individual using a camera; verifying an identity of the individual in response to at least the picture of the face of the individual; and transmitting a digital room key to the mobile device.

In addition to one or more of the features described above, or as an alternative, further embodiments may include that the operations further include: transmitting an access request from the mobile device to an access control, the access request including the digital room key; and actuating the access control in response to the digital room key.

In addition to one or more of the features described above, or as an alternative, further embodiments may include that the operations further include: activating a notification on the mobile device when the identity of the individual is being verified.

In addition to one or more of the features described above, or as an alternative, further embodiments may include that the operations further include: activating a notification on the mobile device when the identity of the individual has been verified.

In addition to one or more of the features described above, or as an alternative, further embodiments may include that the operations further include: activating a notification on the mobile device when the digital room key is transmitted.

In addition to one or more of the features described above, or as an alternative, further embodiments may include that the camera is located on the mobile device.

In addition to one or more of the features described above, or as an alternative, further embodiments may include that the camera is a security camera located on the property.

In addition to one or more of the features described above, or as an alternative, further embodiments may include that verifying an identity of the individual in response to at least the picture of the face of the individual further includes: comparing the picture of the face of the individual to a picture previously captured of the individual.

In addition to one or more of the features described above, or as an alternative, further embodiments may include that verifying an identity of the individual in response to at least the picture of the face of the individual further includes: cross-referencing the picture against at least one of a government database and a hotel database.

According to another embodiment, a computer program product tangibly embodied on a computer readable medium is provided. The computer program product including instructions that, when executed by a processor, cause the processor to perform operations including: detecting a location of a mobile device being carried by an individual; determining that the location of the mobile device is located proximate a property entrance to a property; obtaining a picture of a face of the individual using a camera; verifying an identity of the individual in response to at least the picture of the face of the individual; and transmitting a digital room key to the mobile device.

Technical effects of embodiments of the present disclosure include detecting when an individual arrives on a property, confirming the identity of the individual, and granting a mobile device belonging to the individual access to one or more access controls on the property.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

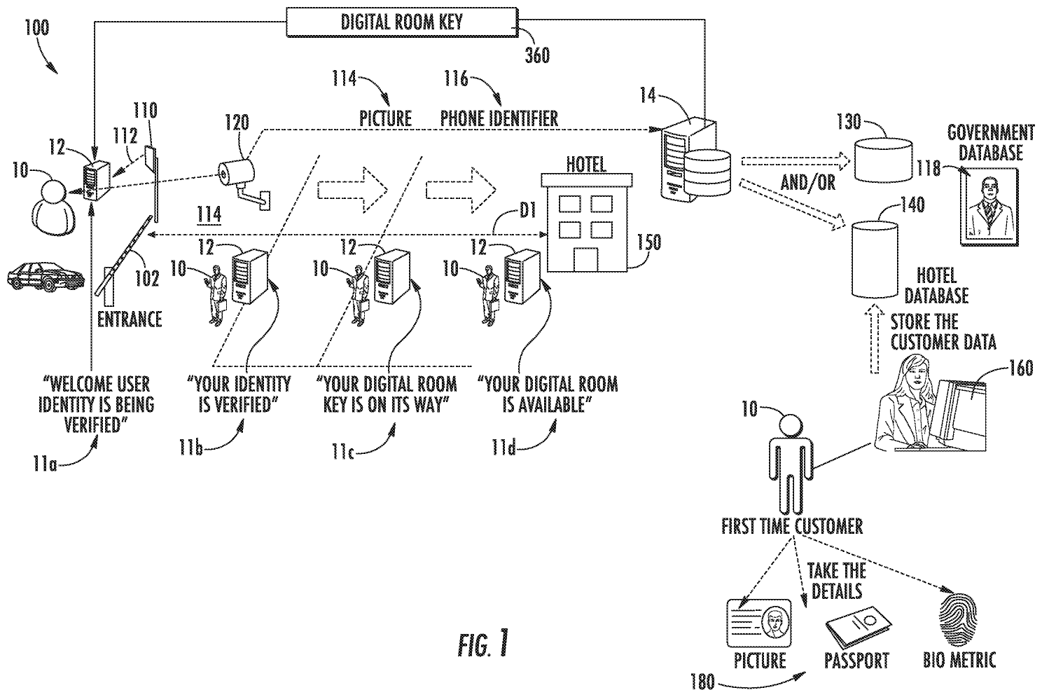

FIG. 1 illustrates a general schematic system diagram of a seamless access system, in accordance with an embodiment of the disclosure;

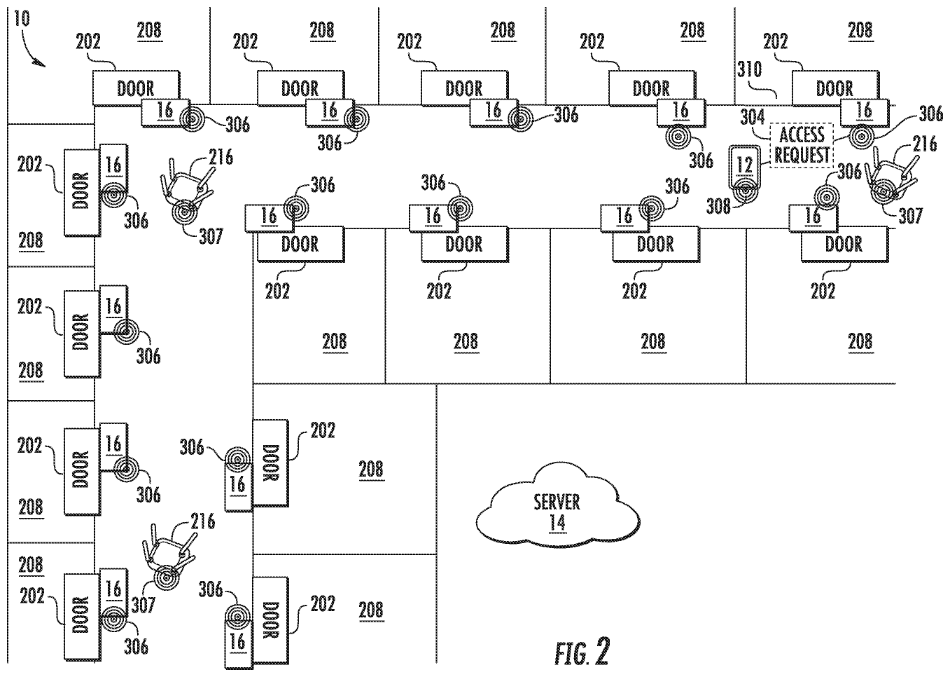

FIG. 2 illustrates a general schematic system diagram of an access control system, in accordance with an embodiment of the disclosure;

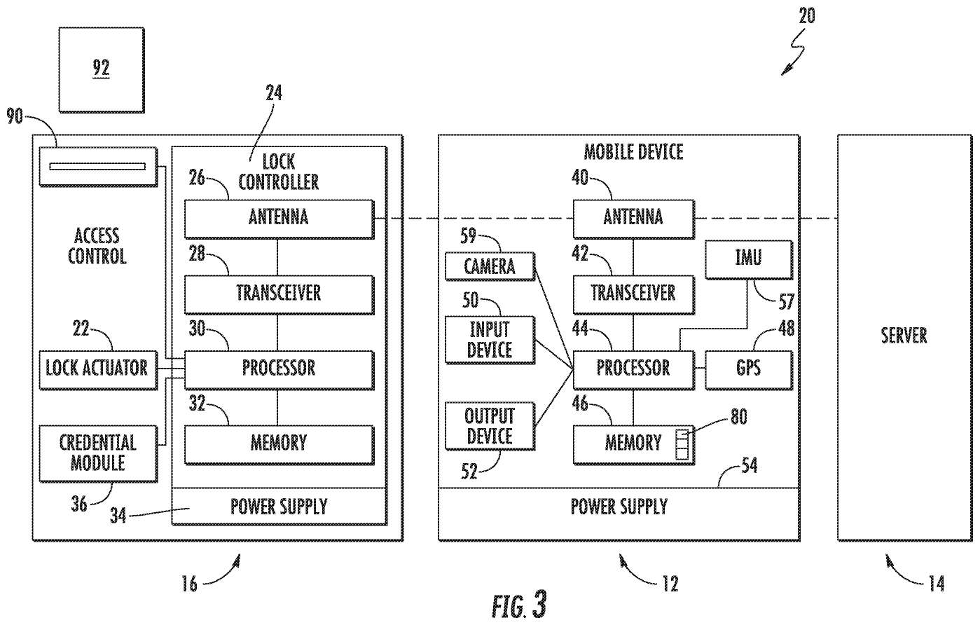

FIG. 3 illustrates a block diagram of an access control, mobile device and server of the access control system of FIG. 1, in accordance with an embodiment of the disclosure; and

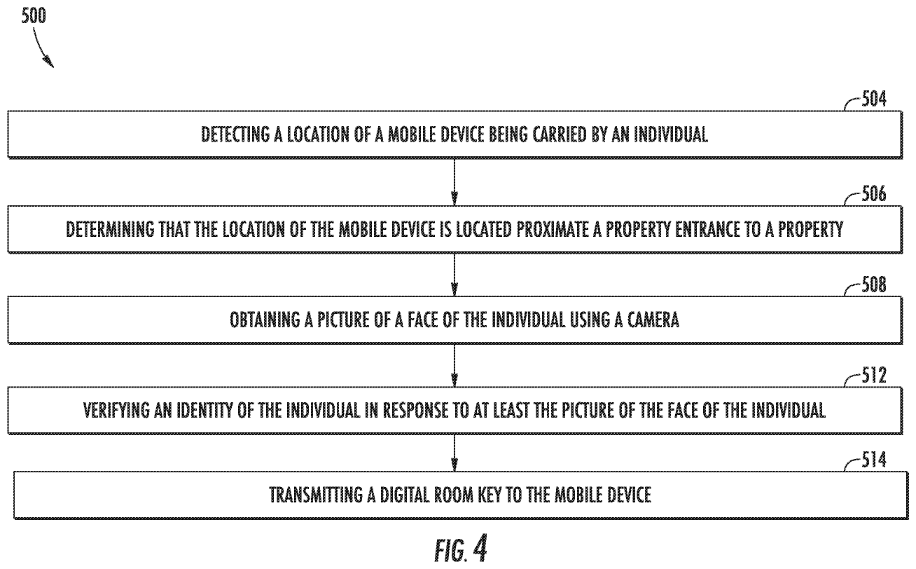

FIG. 4 is a flow diagram illustrating a method of granting seamless access to a room, according to an embodiment of the present disclosure.

### DETAILED DESCRIPTION

A detailed description of one or more embodiments of the disclosed apparatus and method are presented herein by way of exemplification and not limitation with reference to the Figures.

FIG. 1 schematically illustrates a seamless access system 100, according to an embodiment of the present disclosure. The seamless access system 100 is configured to grant of seamless access to a room 208 (see FIG. 2) of a hotel, while confirming the identity of an individual. The seamless access system 100 may generally include a property perimeter beacon 110, a camera 120, and a server 14. As an individual 10 carrying a mobile device 12 approaches a property of a hotel 150, the location of the mobile device 12 may be tracked to determine when the individual 12 will enter a property entrance 102. The property perimeter beacon 110 may detect when the individual 10 carrying the mobile device 12 is proximate the property entrance 102. Alternatively, a global positioning system (not shown) may detect when the mobile device 12 is located proximate the property entrance 102 and an application 80 (see FIG. 3) installed on the mobile device 12 may notify the seamless access system 100.

The property perimeter beacon 110 may be configured to continuously advertise an advertisement 112 to the mobile device 12. The advertisement 112 is the property perimeter beacon 110 declaring its presence to any nearby listening device and if it is a advertisement it is an opportunity for another device (i.e., nearby mobile device 12) to connect to the property perimeter beacon 110. Once the individual 10 is located proximate the property entrance 102, the mobile device 12 will be able to detect an advertisement 112 being projected by the property perimeter beacon 110 via short range wireless communication, such as for example Wi-Fi, Bluetooth, ZigBee, infrared, or any other short-range wireless communication method known to one of skill in the art. The advertisement 112 is detected by the mobile device 12 using the application 80 and then the application 80 will prompt the camera 120 to capture a picture 114 of the individual 10. The picture 114 may be of the face of the individual 10. The picture 114 of the individual 10 is utilized to confirm the identity of the individual 10, discussed further below. In one embodiment, the camera 120 may be a camera located on the mobile device 12 of the individual 10. If the camera 120 is located on the mobile device 12 of the individual 10, then the application 80 may activate a notification on the mobile device 12 instructing the individual 10 to take a picture of their face to confirm their identity when the mobile device 12 detects the advertisement 112 of the property perimeter beacon 110.

In another embodiment, the camera 120 may be a security camera (i.e., g surveillance camera) located on the property 114 of the hotel 150. In one embodiment the camera 120 is a surveillance camera that is continuously taking video and using image processing to determine if an individual 10 is there. The image processing could be informed by the application 80 of ‘who’ is there so the image verification can be performed. In another example, the image processing may perform a lookup from a known database of individuals to determine ‘who’ is the individual 10 and then provides the ‘who’ for comparison to what is provided by the application 80.

In another embodiment, the camera 120 may be a camera located in the vehicle transporting the individual through the property entrance 102. The vehicle may be a car, motorcycle, train, tram, boat, monorail, bus, plane, helicopter, or any other vehicle known to one of skill in the art. The advertisement 112 detected by the mobile device 12 also prompts the application 80 to transmit the phone identifier 116 of the mobile device 12 to the server 14. In an another embodiment, a beacon in the vehicle may emitting an advertisement to be received by the mobile device 12 prompting the application 80 to transmit the phone identifier 116 of the mobile device 12 to the server 14. The phone identifier 116 may be a phone number of the mobile device 12, an email address, a MAC address of their phone, a Bluetooth ID, an International Mobile Equipment Identity (IMEI) number or any other mobile device 12 identifier that can be used to look up and compare the identity against an expected verifiable biometric (i.e. face) that is associated with the identity of the individual 10. In this case, if the video verification was done shortly prior to the arrival of the individual 10 while in a vehicle, then the camera 120 may perform an identification of the individual and/or a verification of the individual 10 was here and provides a certifiable notification to the seamless access system 100 that ‘this individual 10 was here’. If the location is reasonably close or reasonably recent (e.g., based on a policy and/or location of the individual) then the seamless access system 100 could verify the certification and agree that this must be the individual 10 because they were just verified.

The server 14 is in electronic communication with the mobile device 12, the camera 120, a government database 130, and a hotel database 140. The server 14 will then use the picture 114 and the phone identifier 116 to verify the identity of the individual 10 may cross-referencing the picture 114 and the phone identifier 116 against at least one of the government database 130 and the hotel database 140. The government database 130 and the hotel database 140 may contain saved details on the individual 10 with which the server 14 may verify the identity of the individual 10. For example, the government database 130 and the hotel database 140 may contain customer data 180 of the individual 10 including but not limited to pictures 118 of the individual 10 previously captured, the phone identifier of the mobile device 12 belonging to the individual 10, government identification of the individual 10 (e.g., passport, driver's license,), biometric data of the individual 10 (e.g., fingerprints, retinal scan, facial ID), passwords, payment information, reservation details (i.e., check-in dates, check-out dates), room assignments, location of the hotel 150, etc. The pictures 118 of the individual 10 stored in the government database 130 and the hotel database 140 may be pictures 118 previously captured of the individual 10 for a government ID, such as, for example a driver's license or passport. In an embodiment, the server 14 may utilize facial recognition software to compare the picture 114 of the individual 10 to pictures 118 of the individual 10 located on the government database 130 and the hotel database 140.

The individual 10 may receive notifications via the application 80 on the mobile device 12 as their identity is being verified by the server 14. For example, the individual 10 may receive a notification 11a when the identity verification process starts and a notification 11b when the identity verification process is completed (i.e., their identity is verified). The notifications 11a-11d may be visual, audible, and/or vibratory. For example, the notification 11a at the start of the identity verification process may be displayed on the mobile device 12 and may state “Welcome user identity is being verified”. In another example, the notification 11b at the end of the identity verification process may be displayed on the mobile device 12 and may state “Your identity is verified”. If an individual does not receive one or more notifications 11a-11d (e.g., due to network delay or signal issue) during the distance D1 between the property entrance 102 and the hotel 150 then front desk 160 should be informed over SMS or using Bluetooth mesh network.

If the server 14 is able to verify the identity of the individual 10 then a digital room key 360 (e.g., a digital credential) may be transmitted to the mobile device 12 being carried by the individual 10. The digital room key 360 may be a digital credential utilized by the application 80 to unlock an access control 16 to a hotel room 208 located in the hotel 150, discussed further below. The individual 10 may receive notifications 11c, 11d via the application 80 on the mobile device 12 when their digital room key 360 is being prepared and when their digital room key 360 is available for use. For example, the individual 10 may receive notifications 11c via the application 80 on the mobile device 12 displaying the mobile device 12 that “Your digital room key is on its way”. In another example, the individual 10 may receive notifications 11d via the application 80 on the mobile device 12 displaying the mobile device 12 that “Your digital room key is available”.

The entire identity verification process and room key transmission may take place in the distance D1 between the property entrance 102 and the hotel 150, which advantageously allows the individual 10 to skip the hotel front desk 160 and go straight to their room 208 once entering the hotel 150.

If the server 14 is unable to verify the identity of the individual 10 or the individual 10 has been opted out of the automated verification process then it may be indicate that this the individual 10 is a first time customer of the hotel 150. If the server 14 is unable to verify the identity of the individual 10 then the individual 10 may need to check in at a hotel front desk 160. A first time customer may be sent directions to the front desk 160 within the first distance D1. The front desk 160 may collect customer data 180 of the individual 10 and transmit the customer data 180 to the hotel database 140 where it is to be stored for later use by the seamless access system 100. A hotel worker working at the front desk 160 may collect this customer data 180 or a computer kiosk may collect this customer data 180. Referring now to FIG. 2, with continued reference to FIG. 1, an access control system 200 within the hotel 150 is illustrated, in accordance with an embodiment of the present disclosure. The digital room key 360 may be utilized to actuate an access control 16 and gain access to a room 208. The access control 16 may be a door lock that controls access to a hotel room 208. The system 200 generally includes a mobile device 12, a server 14, a wireless access protocol device 216, and an access control 16. The access control system 200 may include any number of access controls 16. It should be appreciated that, although particular systems are separately defined in the schematic block diagrams, each or any of the systems may be otherwise combined or separated via hardware and/or software. In the illustrated embodiment, the access controls 16 may control access through a door 202 to a room 208. The access control system 200 may include any number of doors 202 and rooms 208. Further, there may be multiple doors 202 and access controls 16 for each room 208.

A mobile device 12 belonging to an individual may be granted access to one or more access controls 16 (e.g. a hotel room assigned to the individual) via the digital room key 360. There may be one or more mobile devices 12 assigned to a room 208 (e.g. a husband and a wife in a hotel; or multiple workers in a collaborative workspace). An individual 10 may utilize their mobile device 12 to unlock and/or lock the access control 16 operably connected to their assigned room 208 through an access request 304, which may include the digital room key 360. The mobile device 12 stores the digital room key 360 to unlock and/or lock the access control 16. The digital room key 360 may be used for multiple access controls 16 if there are multiple access controls 16 for a single assigned room 208 or the individual is assigned access to multiple rooms 208. For example, an access control 16 operably connected to an individual's hotel room 208 and an access control 16 operably connected to a hotel pool may respond to the same the digital room key 360. Other digital room keys 360 may be specific to a single access control 16.

Wireless communication may occur between the access control 16 and the mobile device 12 via short range wireless communication, such as for example Wi-Fi, Bluetooth, ZigBee, infrared, or any other short-range wireless communication method known to one of skill in the art. In an embodiment, the short-range wireless communication is Bluetooth. The mobile device 12 may have to be within a selected range of the access control 16 in order to utilize short-range wireless communication. For example, the selected range may be manually set by an individual as a chosen range or automatically set based on the limitations of hardware associated with the mobile device 12 and/or the access control 16. The signal strength of the wireless signal 308 emitted by the mobile device 12 may be varied while inside the hotel 150 and the transmitted power may be set accordingly based on the location of the mobile device 12.

Each access control 16 is a wireless-capable, restricted-access, or restricted-use device such as wireless locks, access control readers for building entry, and other restricted-use machines. The mobile device 12 submits the digital room key 360 to the access controls 16, thereby selectively permitting a user to actuate (i.e., access or activate) functions of the access controls 16. A user may, for example, submit a digital room key 360 to an electromechanical lock to unlock it, and thereby gain access to a room 208.

The mobile device 12 may transmit an access request 304 including the digital room key 360 to the access control 16 by short-range radio transmission when the mobile device 12 is placed proximate the access control 16. The mobile device 12 is a wireless capable handheld device such as a smartphone, smart watch, tablet, laptop, or similar mobile computing device that is operable to communicate with the server 14 and the access controls 16. The server 14 may provide data 320 including digital room keys 360 and other data to the access control 16, such as firmware or software updates to be communicated to one or more of the access controls 16. Although the server 14 is depicted herein as a single device, it should be appreciated that the server 14 may alternatively be embodied as a multiplicity of systems, from which the access controls 16 receives digital room key 360 and other data.

The server 14 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

The access control 16 may be configured to continuously advertise a wireless signal 306 to the mobile device 12. The advertisement is the access control 16 declaring its presence to any nearby listening device and if it is a connectable advertisement it is an opportunity for another device (i.e., nearby mobile device 12) to connect to the access control 16. For example, the wireless signal 306 of the access control 16 may be a Bluetooth signal. The mobile device 12 is configured to detect the wireless signal 306 and determine positional data of the mobile device 12 in response to a signal strength of the wireless signal 306. The positional data of the mobile device 12 may help determine which access control 16 is located proximate the mobile device 12, and thus which access control 16 the mobile device 12 desires to enter.

Positional data of the mobile device 12 may also be determined using the wireless access protocol device 216. The wireless access protocol device 216 may be configured to advertise a wireless signal 307. The advertisement is the wireless access protocol device 216 declaring its presence to any nearby listening device and if it is a connectable advertisement it is an opportunity for another device (i.e., nearby mobile device 12) to connect to the wireless access protocol device 216. For example, the wireless signal 307 of the wireless access protocol device 216 may be a Wi-Fi signal. The mobile device 12 is configured to detect the wireless signal 307 and determine a positional data of the mobile device 12 in response to a signal strength of the wireless signal 307.

Positional data of the mobile device 12 may also be determined using the wireless access protocol device 216 and/or the access controls 16 to detect a wireless signal 308 advertised by the mobile device 12. The mobile device 12 may be configured to advertise a wireless signal 308. The advertisement is the mobile device 12 declaring its presence to any nearby listening device and if it is a connectable advertisement it is an opportunity for another device (i.e., access control 16 or wireless access protocol device 216) to detect this advertisement and triangulate the location of the mobile device 12. The wireless access protocol device 216 and/or the access controls 16 are configured to detect the wireless signal 308 and determine a positional data of the mobile device 12 in response to a signal strength of the wireless signal 308.

Wireless signal interaction data between the mobile device 12 and at least one of the access device 16 and the wireless access protocol device 216 may be transmitted to the server 14 to determine positional data. The server 14 may use signal strength detected between the mobile device 12, access controls 16, and the wireless access protocol device 216 to determine positional data of the mobile device 12. The positional data of the mobile device 12 may be utilized to transmit notifications (i.e., notifications 11a-11d) to the mobile device 12 and/or inform the front desk 160 of the location of the mobile device 12.

Referring now to FIG. 3, with continued reference to FIGS. 1-2, a block diagram of an example electronic lock system 20 including the access control 16, the mobile device 12, and the server 14 is illustrated, in accordance with an embodiment of the present disclosure. The access control 16 generally includes a lock actuator 22, a lock controller 24, a lock antenna 26, a lock transceiver 28, a lock processor 30, a lock memory 32, a lock power supply 34, a lock card reader 90, and a credential module 36.

The access control 16 may have essentially two readers, one reader 90 to read a physical key card 92 and the credential module 36 to communicate with the mobile device 12 via the lock processor 30 and the transceiver 28 and antenna 26. In addition to utilizing the mobile device 12 to actuate the access control 16, a physical key card 92 may also be used to actuate the access control 16 by being inserted into the access control 16 for the access control 16 to read the physical key card 92 (e.g. a magnetic strip on an encoded card 92). The physical key card 92 is capable of being encoded with card data, such as, for example, a magnetic strip or RFID chip. The card data may include credentials similar to the digital room key 360 to grant access to a specific access control 16. For example, for a period the mobile device 12 may be granted access to a specific access control 16, such as, for example, a period of stay/employment for the individual possessing the mobile device 12.

The access control 16 is responsive to the digital room key 360 from the mobile device 12, and may, for example, be the lock of a door lock. Upon receiving and authenticating an appropriate digital room key 360 from the mobile device 12 using the credential module 36, or after receiving card data from lock card reader 90, the lock controller 24 commands the lock actuator 22 to lock or unlock a mechanical or electronic lock. The lock controller 24 and the lock actuator 22 may be parts of a single electronic or electromechanical lock unit, or may be components sold or installed separately. In an embodiment, the access control 16 is composed of separate components—a reader (e.g., transceiver 28 and/or antenna 26) at a door 202, a processor 30 that gets the digital room key 360 from the reader, and then a lock actuator 22 that gets a signal from the processor 30 to actuate an electromechanical lock.

The lock transceiver 28 is capable of transmitting and receiving data to and from at least one of the mobile device 12, the wireless access protocol device 216, and the other access controls 16. The lock transceiver 28 may, for instance, be a near field communication (NFC), Bluetooth, infrared, ZigBee, or Wi-Fi transceiver, or another appropriate wireless transceiver. The lock antenna 26 is any antenna appropriate to the lock transceiver 28. The lock processor 30 and lock memory 32 are, respectively, data processing, and storage devices. The lock processor 30 may, for instance, be a microprocessor that can process instructions to the validate digital room key 360 and determine the access rights contained in the digital room key 360 or to pass messages from a transceiver to a credential module 36 and to receive a response indication back from the credential module 36. The lock memory 32 may be RAM, EEPROM, or other storage medium where the lock processor 30 can read and write data including but not limited to lock configuration options. The lock power supply 34 is a power source such as line power connection, a power scavenging system, or a battery that powers the lock controller 24. In other embodiments, the lock power supply 34 may only power the lock controller 24, with the lock actuator 22 powered primarily or entirely by another source, such as user work (e.g. turning a bolt).

While FIG. 3 shows the lock antenna 26 and the transceiver 28 connected to the processor 30, this is not to limit other embodiments that may have additional antenna 26 and transceiver 28 connected to the credential module 36 directly. The credential module 36 may contain a transceiver 28 and antenna 26 as part of the credential module 36. Or the credential module 36 may have a transceiver 28 and antenna 26 separately from the processor 30 which also has a separate transceiver 28 and antenna 26 of the same type or different. In some embodiments, the processor 30 may route communication received via transceiver 28 to the credential module 36. In other embodiments the credential module 36 may communicate directly to the mobile device 12 through the transceiver 28.

The mobile device 12 generally includes a key antenna 40, a key transceiver 42, a key processor 44, a key memory 46, a GPS receiver 48, an input device 50, an output device 52, a key power supply 54, a camera 59, and an inertial measurement unit (IMU) sensor 57. The key transceiver 42 is a transceiver of a type corresponding to the lock transceiver 28, and the key antenna 40 is a corresponding antenna. In some embodiments, the key transceiver 42 and the key antenna 40 may also be used to communicate with the server 14. In other embodiments, one or more separate transceivers and antennas may be included to communicate with server 14. The key memory 46 is of a type to store a plurality of digital room keys 360 locally on the mobile device 12. The mobile device 12 may also include a mobile device application 80. Embodiments disclosed herein, may operate through the mobile device application 80 installed on the mobile device 12. The IMU sensor 57 may be a sensor such as, for example, an accelerometer, a gyroscope, or a similar sensor known to one of skill in the art. The camera 59 is configured to still and/or video images. In an embodiment, the camera 59 of the mobile device 12 may be the camera 120 of FIG. 1.

Referring now to FIG. 4, with continued reference to FIGS. 1-3, a flow chart of a method 500 of granting seamless access to a room 208, in accordance with an embodiment of the present disclosure. In an embodiment, the method 500 may be performed by the seamless access system 100. In another embodiment, the method 500 may be performed or coordinated by the server 14 of the seamless access system 100. At block 504, a location of a mobile device 12 being carried by an individual 10 is detected. At block 506, it is determined that the location of the mobile device 12 is located proximate a property entrance 102 to a property 114. At block 508, a picture 114 of a face of the individual 10 is obtained using a camera 120. The camera 120 may capture the picture 114 and transmit the picture 114 to the server 14. As discussed above, the camera 120 may be located on the mobile device 12 or the camera 120 may be a security camera located on the property 114. A phone identifier 116 of the mobile device 12 may also be obtained prior to method 500 or during method 500. The phone identifier 116 may be obtained by the mobile device 12 transmitting the phone identifier 116 to the server 14 through the application 80.

At block 512, an identity of the individual 10 is verified in response to at least the phone identifier 116 of the mobile device 12 and the picture 114 of the face of the individual 10. A notification 11a may be activated on the mobile device 12 when the identity of the individual 10 is being verified. Also, a notification 11b may be activated on the mobile device 12 when the identity of the individual 10 has been verified. As discussed above, the identity of the individual 10 may be verified by comparing the picture 114 of the face of the individual 10 to a picture 118 previously captured of the individual 10. The comparison of the pictures 114, 118 may be conducted using image recognition technology. As discussed above, the identity of the individual 10 may be verified by cross-referencing the picture 114 and the phone identifier 116 against at least one of a government database 130 and a hotel database 140.

At block 514, a digital room key 360 is transmitted to the mobile device 12. Additionally, a notification 11c, 11d may be activated on the mobile device 12 when digital room key 360 is transmitted. The method 500 may further comprise: transmitting an access request 304 from the mobile device 12 to an access control 16 and actuating the access control 16 in response to the digital room key 360 included in the access request 304.

While the above description has described the flow process of FIG. 4 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of granting seamless access to a room, the method comprising:
detecting a location of a mobile device being carried by an individual;
determining that the location of the mobile device is located proximate a property entrance to a property;
obtaining a picture of a face of the individual using a camera;
verifying an identity of the individual in response to at least the picture of the face of the individual; and
transmitting a digital room key to the mobile device.

2. The method of claim 1, further comprising:
transmitting an access request from the mobile device to an access control, the access request including the digital room key; and
actuating the access control in response to the digital room key.

3. The method of claim 1, further comprising:
activating a notification on the mobile device when the identity of the individual is being verified.

4. The method of claim 1, further comprising:
activating a notification on the mobile device when the identity of the individual has been verified.

5. The method of claim 1, further comprising:
activating a notification on the mobile device when the digital room key is transmitted.

6. The method of claim 1, wherein the camera is located on the mobile device.

7. The method of claim 1, wherein the camera is a security camera located on the property.

8. The method of claim 1, wherein verifying an identity of the individual in response to at least the picture of the face of the individual further comprises:
comparing the picture of the face of the individual to a picture previously captured of the individual.

9. The method of claim 1, wherein verifying an identity of the individual in response to at least the picture of the face of the individual further comprises:
cross-referencing the picture against at least one of a government database and a hotel database.

10. A seamless access system, comprising
a processor; and
a memory comprising computer-executable instructions that, when executed by the processor, cause the processor to perform operations, the operations comprising:
detecting a location of a mobile device being carried by an individual;
determining that the location of the mobile device is located proximate a property entrance to a property;
obtaining a picture of a face of the individual using a camera;
verifying an identity of the individual in response to at least the picture of the face of the individual; and
transmitting a digital room key to the mobile device.

11. The seamless access system of claim 10, wherein the operations further comprise:
transmitting an access request from the mobile device to an access control, the access request including the digital room key; and
actuating the access control in response to the digital room key.

12. The seamless access system of claim 10, wherein the operations further comprise:
activating a notification on the mobile device when the identity of the individual is being verified.

13. The seamless access system of claim 10, wherein the operations further comprise:
activating a notification on the mobile device when the identity of the individual has been verified.

14. The seamless access system of claim 10, wherein the operations further comprise:
activating a notification on the mobile device when the digital room key is transmitted.

15. The seamless access system of claim 10, wherein the camera is located on the mobile device.

16. The seamless access system of claim 10, wherein the camera is a security camera located on the property.

17. The seamless access system of claim 10, wherein verifying an identity of the individual in response to at least the picture of the face of the individual further comprises:
comparing the picture of the face of the individual to a picture previously captured of the individual.

18. The seamless access system of claim 10, wherein verifying an identity of the individual in response to at least the picture of the face of the individual further comprises:
cross-referencing the picture against at least one of a government database and a hotel database.

19. A computer program product tangibly embodied on a computer readable medium, the computer program product including instructions that, when executed by a processor, cause the processor to perform operations comprising:
detecting a location of a mobile device being carried by an individual;
determining that the location of the mobile device is located proximate a property entrance to a property;
obtaining a picture of a face of the individual using a camera;
verifying an identity of the individual in response to at least the picture of the face of the individual; and
transmitting a digital room key to the mobile device.
